(19) United States
(12) Patent Application Publication
(10) Pub. No.: US 2015/0177419 A1
(43) Pub. Date: Jun. 25, 2015

(54) OPTICAL LENS AND MOBILE TERMINAL

(71) Applicant: LARGAN PRECISION CO., LTD., Taichung City (TW)

(72) Inventors: Kuo-Chiang CHU, Taichung City (TW); Chien-Pang CHANG, Taichung City (TW)

(73) Assignee: LARGAN PRECISION CO., LTD., Taichung City (TW)

(21) Appl. No.: 14/156,454

(22) Filed: Jan. 16, 2014

(30) Foreign Application Priority Data
Dec. 23, 2013 (TW) 102147782

(51) Int. Cl. G02B 1/11

(52) U.S. Cl. CPC G02B 1/11

(57) ABSTRACT

An optical lens includes a lens barrel, an optical lens system and an anti-reflection film. The lens barrel is made of black plastic material. The optical lens system is located inside the lens barrel. The anti-reflection film is located on an object-side outer surface of the lens barrel.

### RELATED APPLICATIONS

This application claims priority to Taiwan Application Serial Number 102147782, filed Dec. 23, 2013, which is incorporated by reference herein in it entirety.

### BACKGROUND

1. Technical Field

The present disclosure relates to an optical lens. More particularly, the present disclosure relates to an optical lens having an anti-reflection outer surface.

2. Description of Related Art

A conventional lens barrel of an optical lens is mainly made of black plastic material for reducing a reflection of the visible light from an outer surface of the lens barrel. However, the glossy reflection still can be seen on the outer surface of the lens barrel since there are limited material choices in making the lens barrel. As a result, this shows that the reflection of the visible light still exist on the outer surface of the lens barrel, even though the lens barrel is made of black plastic material.

An optical lens usually includes a transparent shield to protect the lenses inside the lens barrel from contamination. However, when a light source enters the transparent shield, the light source will then be reflected by the outer surface of a lens barrel that faces the object during the image capturing process. The light source will thereby be reflected again by the transparent shield and enters an optical lens system. Therefore, this reflection will not be favorable for the resolving power and image quality of the optical lens system, when a mobile terminal is under an image capturing process. Moreover, when the optical lens is installed in the dark-colored mobile terminal, the glossy reflection will also not be favorable for the entire aesthetic appearance of the mobile terminal,

### SUMMARY

According to one aspect of the present disclosure, an optical lens includes a lens barrel, an optical lens system and an anti-reflection film. The lens barrel is made of black plastic material. The optical lens system is located inside the lens barrel. The anti-reflection film is located on an object-side outer surface of the lens barrel.

According to another aspect of the present disclosure, a mobile terminal includes the optical lens according to the aforementioned aspect.

### BRIEF DESCRIPTION OF THE DRAWINGS

The disclosure can be more fully understood by reading the following detailed description of the embodiment, with reference made to the accompanying drawings as follows:

FIG. 1 is a cross-sectional view of an optical lens according to the 1st embodiment of the present disclosure;

FIG. 2 is a front view of the optical lens according to FIG. 1;

FIG. 3 is a schematic view of the anti-reflection film of the optical lens according to FIG. 1;

FIG. 4 is a reflectivity comparison of two different optical lenses according to the 1st embodiment of the present disclosure within a visible wavelength range:

FIG. 5 is a schematic view of an anti-reflection film of an optical lens according to the 2nd embodiment of the present disclosure;

FIG. 6 is a reflectivity comparison of two different optical lenses according to the 2nd embodiment of the present disclosure within a visible wavelength to range:

FIG. 7 is a schematic view of an anti-reflection film of an optical lens according to the 3rd embodiment of the present disclosure;

FIG. 8 a reflectivity comparison of two different optical lenses according to the 3rd embodiment of the present disclosure within a visible wavelength range; and

FIG. 9 is a schematic view of a mobile terminal according to the 4th embodiment of the present disclosure,

### DETAILED DESCRIPTION

An optical lens includes a lens barrel, an optical lens system and an anti-reflection film. The lens barrel is made of black plastic material. The optical lens system is located inside the lens barrel. The anti-reflection film is located on an object-side outer surface of the lens barrel. As a result, it is favorable for reducing the gloss reflection which is on the object-side outer surface of the lens barrel by depositing the anti-reflection film. It is also favorable for further reducing the reflection of the optical lens so as to improve an image quality.

When a total number of layers of the anti-reflection film is ARL, and the following condition is satisfied: ARL=1. Therefore, it is favorable for effectively controlling the coating cost and having anti-reflection effects through depositing a proper layer count of the anti-reflection film.

In other words, the anti-reflection film can include at least one first kind of film layer, wherein a refractive index of the first kind of film layer is NA, and the following condition is satisfied: NA≦1.5. Therefore, it is favorable for enhancing the abrasion resistance of the outer surface of lens barrel.

When a thickness of the anti-reflection film is LT, and a wavelength of light in the visible region is A, the following condition is satisfied: ¼λ≦LT. Therefore, it is favorable for further enhancing the anti-reflection.

When an average reflectivity of the anti-reflection film of an optical lens within a visible wavelength range is ReF, and the following condition is satisfied: ReF≦2.5%. Therefore, it is favorable for reducing reflectivity in the visible range. Preferably, the folio wing condition is satisfied: ReF≦1%. More preferably, the following condition is satisfied: ReF≦0.5%.

When a total number of layers of the anti-reflection film is ARL, and the following condition is satisfied: 2≦ARL≦15. Therefore it is favorable for enhancing the anti-reflection. In addition, the total number of layers of the anti-reflection film can satisfy the following condition: ARL=2n, wherein n is a positive integer. Therefore, it is favorable for controlling the coating cost when the total number of layers of the anti-reflection film is plural. Moreover, the total number of layers of the anti-reflection film can satisfy the following condition: ARL=2n+1, wherein n is a positive integer. Therefore, it is favorable for effectively reducing the gloss reflection when the total number of layers of the anti-reflection film is plural.

The anti-reflection film can include at least one first kind of film layer and at least one second kind of film layer, wherein the first kind of film layer can be made of SiO₂ or MgF₂, and the second kind of film layer can be made of TiO₂, Ta₂O₅ or Nb₂O₅. Moreover, when the refractive index of the first kind of film layer is NA, and the refractive index of the second kind of film layer is NB, the following conditions are satisfied: NA≦1.5; and 1.8≦NB. Therefore, it is favorable for arranging proper materials for the first kind of film layer and the second kind of film layer since there are several options as mentioned above so as to enhance the anti-reflection.

According to the optical lens of the present disclosure, the anti-reflection film can be connected to the object-side outer surface of the lens barrel via the first kind of film layer or the second kind of film layer of the anti-reflection film. When the anti-reflection film can be connected to the object-side outer surface of the lens barrel via the first kind of film layer thereof, the anti-reflection film can be coated on the lens barrel easily. When the anti-reflection film can be connected to the object-side outer surface of the lens barrel via the second kind of film layer thereof, the coating cost can be reduced.

According to the present disclosure, a mobile terminal is provided. The mobile terminal includes the aforementioned optical lens of the present disclosure. Therefore, it is favorable for effectively reducing the reflection of the optical lens installed in the mobile terminal so as to reduce the gloss reflection on the object-side outer surface of the lens barrel.

According to the above description of the present disclosure, the following 1st-4th specific embodiments are provided for further explanation.

### 1st Embodiment

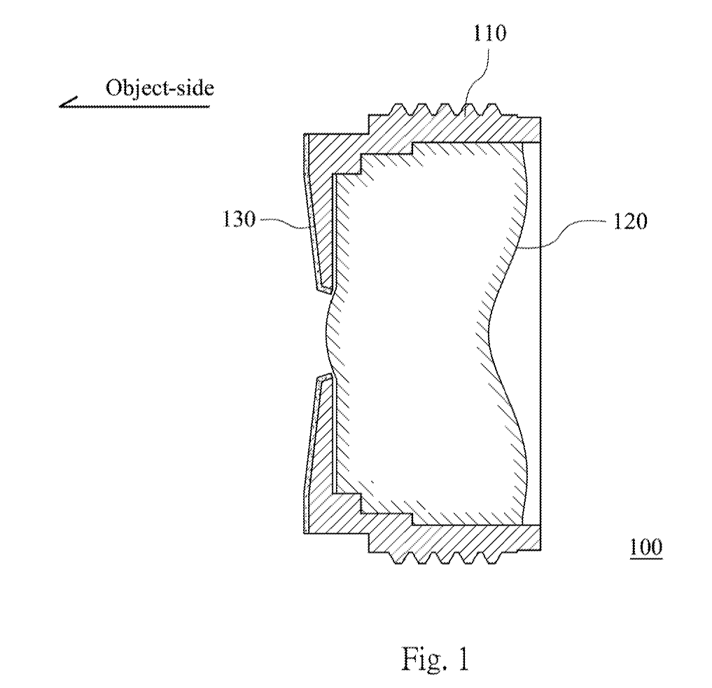

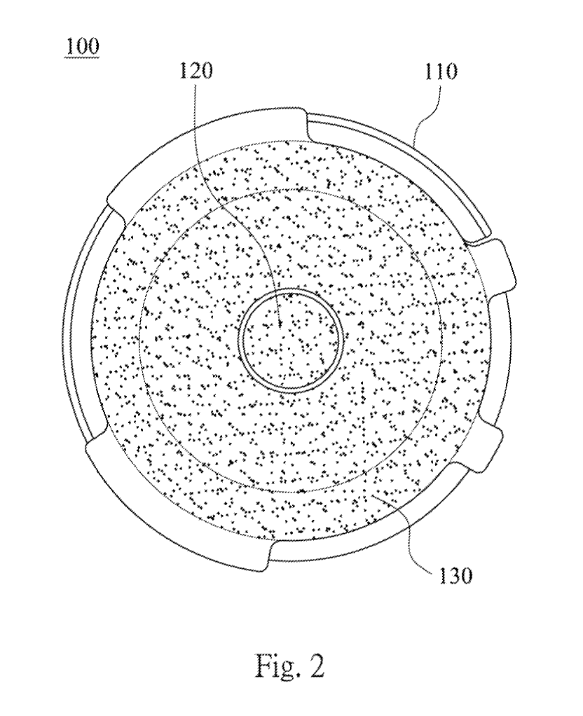

FIG. 1 is a cross-sectional view of an optical lens 100 according to the 1st embodiment of the present disclosure. FIG. 2 is a front view of the optical lens 100 according to FIG. 1. In FIG. 1, the optical lens 100 includes a lens barrel 110, an optical lens system 120 and an anti-reflection film 130. The lens barrel 110 is made of black plastic material. The optical lens system 120 is located inside the lens barrel 110. In FIG. 2, the anti-reflection film 130 is located on the object-side outer surface of the lens barrel 110,

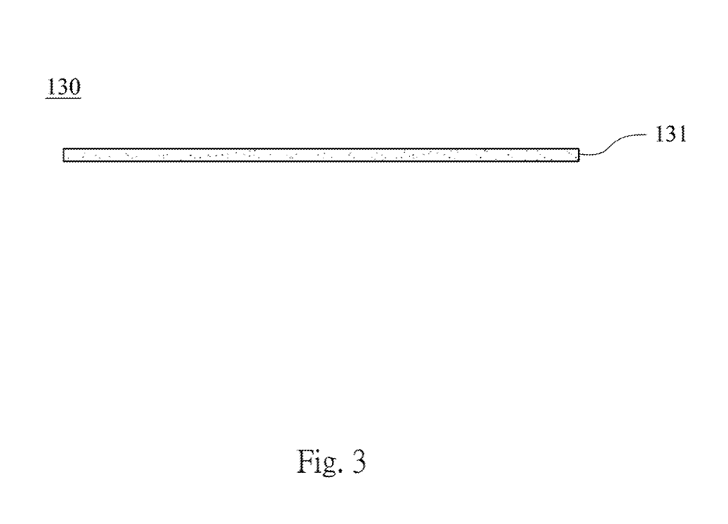

FIG. 3 is a schematic view of the anti-reflection film 130 of the optical lens 100 according to FIG. 1. In FIG. 3, a total number of layers of the anti-reflection film 130 is ARL, and ARL=1. The anti-reflection film 130 include one first kind of film layer 131, wherein the first kind of film layer 131 is made of SiO₂, but is not limited thereto. The first kind of film layer 131 can also be made of MgF₂. Table 1 shows the material, thickness and reflectivity of each film layer in the anti-reflection film 130,

TABLE 1

| | | Thickness | | |
|---|---|---|---|---|
| No. | Material | (nm) | Reflectivity | Type of layer |
| 1 | SiO₂ | 92.44 | 1.46 | First kind of film layer 131 |

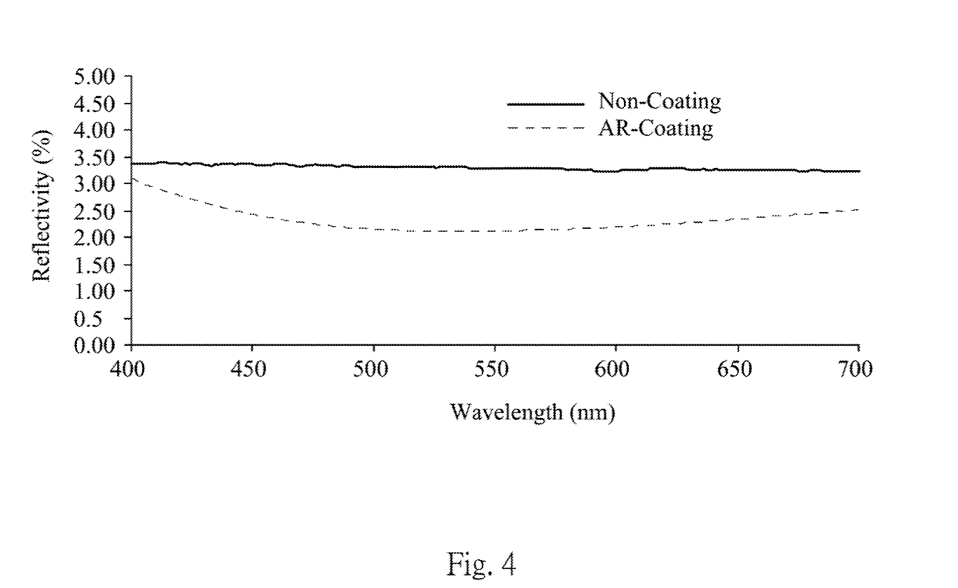

FIG. 4 is a reflectivity comparison of two different optical lenses within a visible wavelength range of 400 nm to 700 nm. In FIG. 4, Non-Coating represents an optical lens which is not coated with an anti-reflection film, and AR-Coating represents the optical lens 100 which is coated with the anti-reflection film 130. Moreover, Table 2 shows the average reflectivity of the Non-Coating and the average reflectivity of AR-Coating within the visible wavelength range of 400 nm to 700 nm.

TABLE 2
(Average reflectivity (%) within the wavelength range of 400 nm to
700 nm)

| Non-Coating | AR-Coating |
|---|---|
| 3.30% | 2.33% |

### 2nd Embodiment

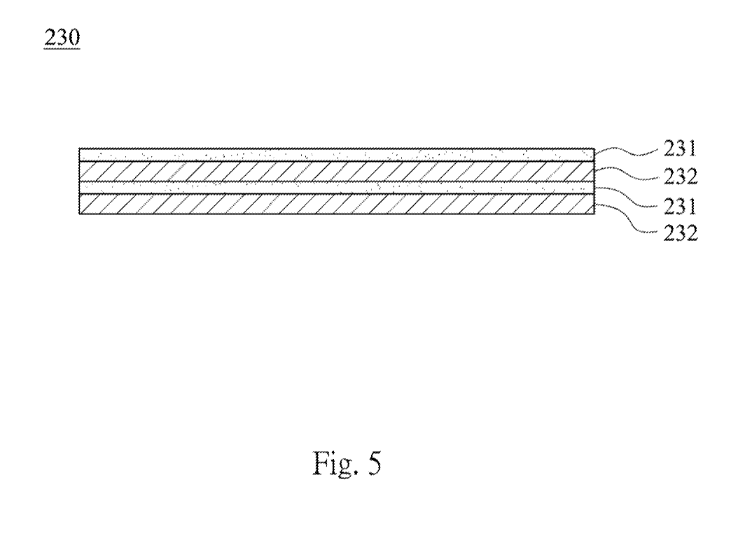

FIG. 5 is a schematic view of an anti-reflection film 230 of an optical lens according to the 2nd embodiment of the present disclosure. Since the relationship and structure between a lens barrel an optical lens system and an anti-reflection film layer 230 of an optical lens is the same as the ones shown in FIG. 1 and FIG. 2, the 2nd embodiment will not otherwise herein provided.

In FIG. 5, a total number of layers of the anti -reflection film 230 is ARL, and ARL=4. More specifically, the anti-reflection film 230 include two first kind of film layers 231 and two second kind of film layers 232, wherein the two first kind of film layers 231 and the two second kind of film layers 232 are alternately stacked. Furthermore, the anti-reflection film 230 is connected to the object-side outer surface of the lens barrel via the second kind of film layer 232 thereof. Moreover, the first kind of film layer 231 is made of SiO₂ and the second kind of film layer 232 is made of TiO₂, but are not limited thereto. The first kind of film layer 231 can also be made of MgF₂, the second kind of film layer 232 can also be made of Ta₂O₅ or Nb₂O₅.

Table 3 shows the material, thickness and reflectivity of each film layer in the anti-reflection film 230. In Table 3, each film layer of the anti-reflection film 230 is numbered 1 to 4 in order, from the film layer closest to the object-side outer surface of the lens barrel to the layer closest to the object.

TABLE 3

| | | Thickness | Re- | | |
|---|---|---|---|---|---|
| No. | Material | (nm) | flectivity | Type of layer | |
| 4 | SiO₂ | 92.48 | 1.46 | First kind of film layer | 231 |
| 3 | TiO₂ | 117.70 | 2.34 | Second kind of film layer | 232 |
| 2 | SiO₂ | 28.70 | 1.46 | First kind of film layer | 231 |
| 1 | TiO₂ | 17.11 | 2.34 | Second kind of film layer | 232 |

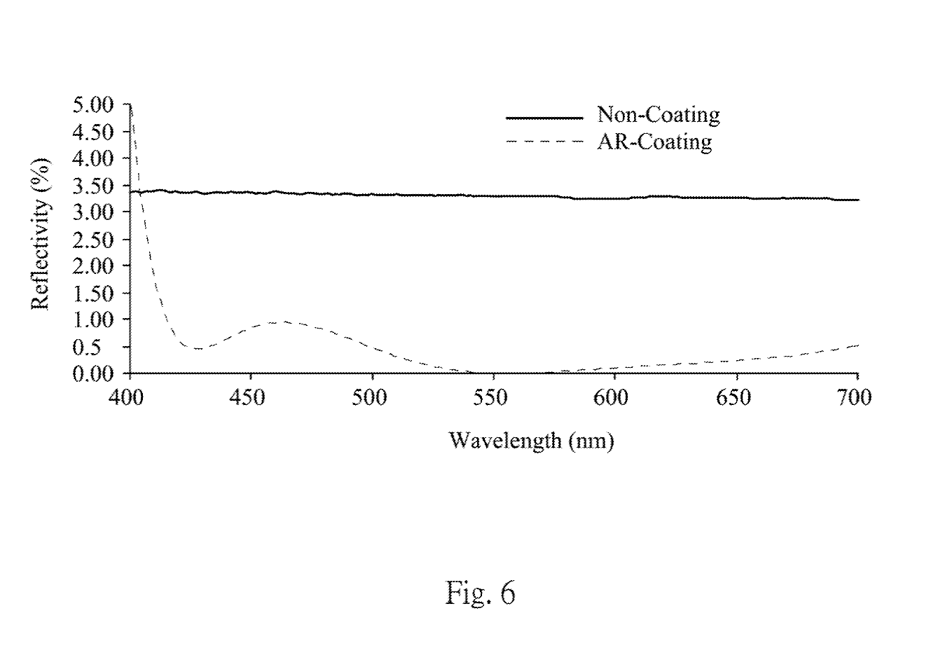

FIG. 6 is a reflectivity comparison of two different optical lenses within a visible wavelength range of 400 nm to 700 nm. In FIG. 6, Non-Coating represents an optical lens which is not coated with an anti-reflection film, and AR-Coating represents the optical lens which is coated with the anti-reflection film 230. Moreover, Table 4 shows the average reflectivity of the Non-Coating and the average reflectivity of AR-Coating within the visible wavelength range of 400 nm to 700 nm.

TABLE 4
(Average reflectivity (%) within the wavelength range of 400 nm to
700 nm)

| Non-Coating | AR-Coating |
|---|---|
| 3.30% | 0.47% |

### 3rd Embodiment

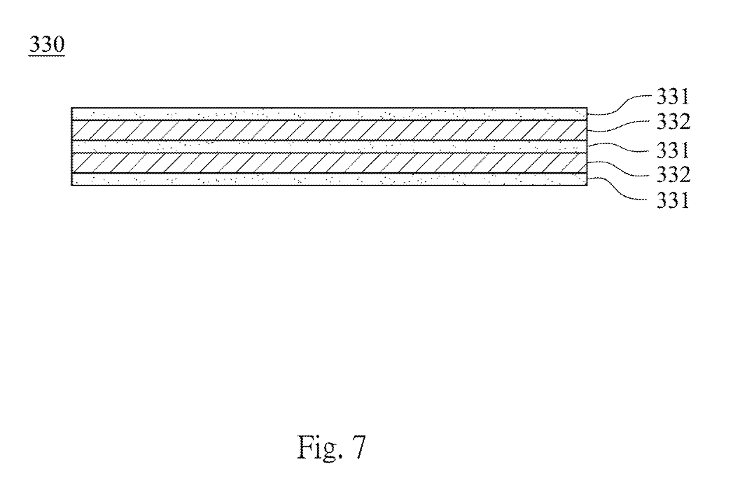

FIG. 7 is a schematic view of an anti-reflection film 330 of an optical lens according to the 3rd embodiment of the present disclosure. Since the relationship and structure between a lens barrel, an optical lens system and an anti-reflection film layer 330 of an optical lens is the same as the ones shown in FIG. 1 and FIG. 2 respectively, the 3rd embodiment will not otherwise herein provided.

In FIG. 7, a total number of layers of the anti-reflection film 330 is ARL, and ARL=5. More specifically, the anti-reflection film 330 include three first kind of film layers 331 and two second kind of film layers 332, wherein the three first kind of film layers 331 and the two second kind of film layers 332 are alternately stacked. Furthermore, the anti-reflection film 330 is connected to the object-side outer surface of the lens barrel via the first kind of film layer 331 thereof. Moreover, the first kind of film layer 331 is made of SiO₂ and the second kind of film layer 332 is made of TiO₂, but are not limited thereto. The first kind of film layer 331 can also be made of MgF₂, and the second kind of film layer 332 can also be made of Ta₂O₅ or Nb₂O₅.

Table 5 shows the material, thickness and reflectivity of each film layer in the anti-reflection film 330. In Table 5, each film layer of the anti-reflection film 330 is numbered 1 to 5 in order, from the film layer closest to the outer surface of the lens barrel to the layer closest to the object.

TABLE 5

| | | Thickness | Re- | | |
|---|---|---|---|---|---|
| No. | Material | (nm) | flectivity | Type of layer | |
| 5 | SiO₂ | 89.70 | 1.46 | First kind of film layer | 331 |
| 4 | TiO₂ | 112.82 | 2.34 | Second kind of film layer | 332 |
| 3 | SiO₂ | 35.67 | 1.46 | First kind of film layer | 331 |
| 2 | TiO₂ | 15.00 | 2.34 | Second kind of film layer | 332 |
| 1 | SiO₂ | 51.80 | 1.46 | First kind of film layer | 331 |

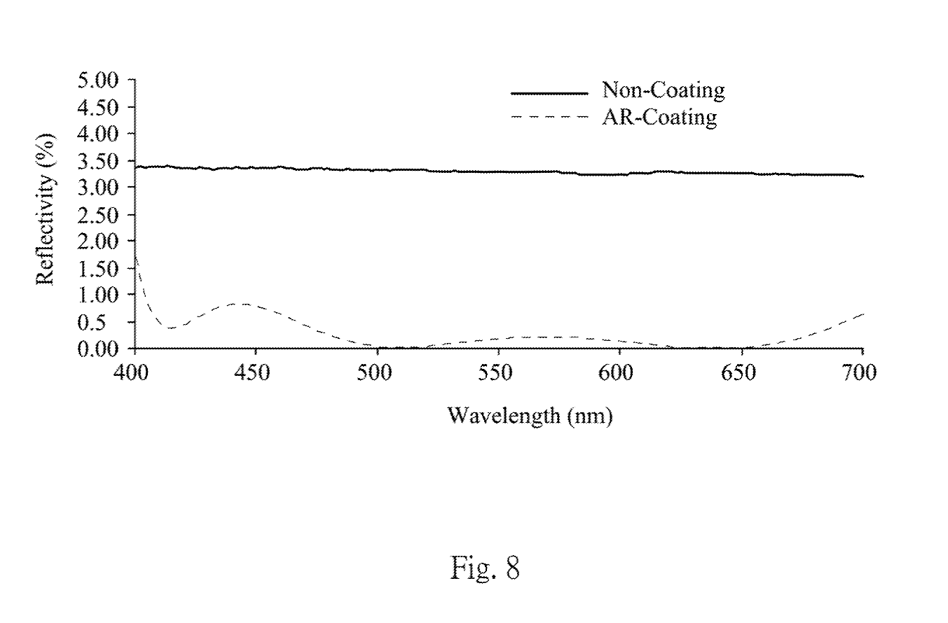

FIG. 8 is a reflectivity comparison of two different optical lenses within a visible wavelength range of 400 nm to 700 nm. In FIG. 8, Non-Coating represents an optical lens which is not coated with an anti-reflection film, and AR-Coating represents the optical lens which is coated with the anti-reflection film 330. Moreover, Table 6 shows the average reflectivity of the Non-Coating and the average reflectivity of AR-Coating within the visible wavelength range of 400 nm to 700 nm.

TABLE 6
(Average reflectivity (%)within the wavelength range of 400 nm to
700 nm)

| Non-Coating | AR-Coating |
|---|---|
| 3.30% | 0.27% |

### 4th Embodiment

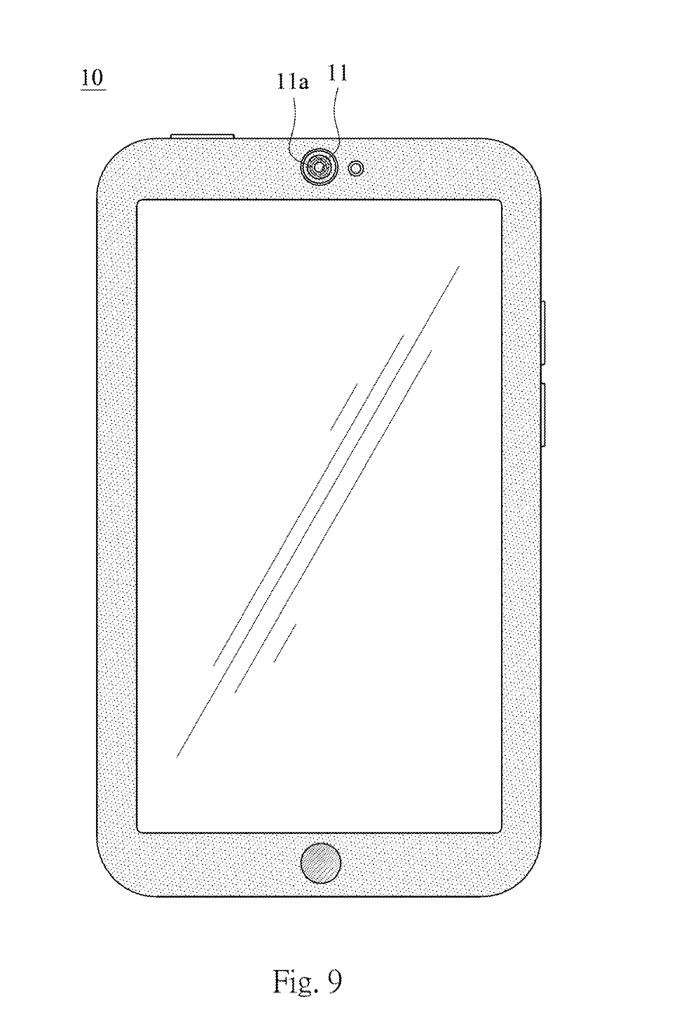

FIG. 9 is a schematic view of a mobile terminal 10 according to the 4th embodiment of the present disclosure. In the 4th embodiment, the mobile terminal 10 is a smart phone. The mobile terminal 10 includes an optical lens 11, wherein the optical lens 11 includes a lens barrel (not otherwise herein labeled), an optical lens system (not otherwise herein labeled), and an anti-reflection film 11a. The detailed structure of an optical lens 11 can be similar to the ones shown in the 1st embodiment, the 2nd embodiment, and the 3rd embodiment.

The foregoing description, for purpose of explanation, has been described with reference to specific embodiments. It is to be noted that TABLES 1-6 show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings,

What is claimed is:

1. An optical lens comprising:
a lens barrel;
an optical lens system; and
an anti-reflection film;
wherein the lens barrel is made of black plastic material, the optical lens system is located inside the lens barrel, and the anti-reflection film is located on an object-side outer surface of the lens barrel.

2. The optical lens of claim 1, wherein a total number of layers of the anti-reflection film is ARL, and the following condition is satisfied:
ARL=1.

3. The optical lens of claim 2, wherein the anti-reflection film comprises a first kind of film layer, and a refractive index of the first kind of film layer is NA, and the following condition is satisfied:
NA≦1.5.

4. The optical lens of claim 2, wherein a thickness of the anti-reflection film is LT, and a wavelength of light in a visible region is λ, and the following condition is satisfied:
¼λ≦LT.

5. The optical lens of claim 2, wherein an average reflectivity of the anti-reflection film of the optical lens within a visible wavelength range is ReF, and the following condition is satisfied:
ReF≦2.5%

6. The optical lens of claim 1, wherein a total number of layers of the anti-reflection film is ARL, and the following condition is satisfied:
2≦ARL≦15.

7. The optical lens of claim 6, wherein the total number of layers of the anti-reflection film is ARL, and the following condition is satisfied:
ARL=2n, wherein n is a positive integer.

8. The optical lens of claim 7, wherein the anti-reflection film comprises at least one first kind of film layer and at least one second kind of film layer, wherein a refractive index of the first kind of film layer is NA, a refractive index of the second kind of film layer is NB, and the following conditions are satisfied:
NA≦1.5; and
1.8≦NB.

9. The optical lens of claim 8, wherein the anti-reflection film is connected to the object-side outer surface of the lens barrel via the second kind of film layer of the anti-reflection film.

10. The optical lens of claim 6, wherein the total number of layers in the anti-reflection film is ARL, and the following condition is satisfied:
ARL=2n+1, wherein n is a positive integer.

11. The optical lens of claim 10, wherein the anti-reflection film comprise at last one first kind of film: layer and at least one second kind of film layer, wherein a refractive index of the first kind of film layer is NA, a refractive index of the second kind of film layer is NB, and the following conditions are satisfied:
NA≦1.5; and
1.8≦NB.

12. The optical lens of claim 11, wherein the anti-reflection film is connected to the object-side outer surface of the lens barrel via the first kind of film layer of the anti-reflection film.

13. The optical lens of claim 6, wherein an average reflectivity of the anti-reflection film of the optical lens within a visible wavelength range is ReF, and the following condition is satisfied:
ReF≦1%.

14. The optical lens of claim 13, wherein the average reflectivity of the anti-reflection film of the optical lens within the visible wavelength range is ReF, and the following condition is satisfied:
ReF≦0.5%.

15. A mobile terminal, comprising:
the optical lens of claim 1.
